(19) United States
(12) Patent Application Publication
(10) Pub. No.: US 2024/0198502 A1
(43) Pub. Date: Jun. 20, 2024

(54) TORQUE WRENCH

(71) Applicant: William Tools Co., Ltd., Taichung City (TW)

(72) Inventor: Shui-Lai Chiang, Taichung City (TW)

(21) Appl. No.: 18/542,129

(22) Filed: Dec. 15, 2023

(30) Foreign Application Priority Data
Dec. 16, 2022 (TW) 111148487

(51) Int. Cl. B25B 23/142

(52) U.S. Cl. CPC B25B 23/1425

(57) ABSTRACT

A torque wrench is provided, wherein the torque wrench includes: a main body defining an axial direction and including a work portion and a housing connected to each other; a grip rotatably connected to an end of the housing; a torque transmission mechanism including a torque adjustment member, the torque adjustment member being rotatably disposed in the main body; a torque sensing mechanism including a sensing assembly and an output port, the output port being configured to be electrically connected to an output unit to receive and transmit a torque sensing signal; an adjustment mechanism including a rotatable member, a driving member and a limitation member, the grip being disposed around the rotatable member and rotatable with the rotatable member, the rotatable member being disposed around the driving member and rotatable with the driving member.

### BACKGROUND OF THE INVENTION

### Field of the Invention

The present invention relates to a torque wrench.

### Description of the Prior Art

A torque wrench capable of adjusting torque setting value is usually used in fastening or unfastening fasteners, which can avoid problems such as damage to the object or the fastener due to over-tightening.

In the conventional torque wrench, such as that disclosed in TW M616790, the adjustment mechanism for adjusting torque is located at an end of the handle, and the size of the adjustment mechanism is small, so that it can only be rotated by applying force with fingers during adjustment. However, the area on which the force is applied is too small and difficult to apply force. In addition, it can only check the torque value during the torque adjustment by looking at the table on the knob and record the torque value manually, which results in great inconvenience and poor efficiency in operation.

The present invention is, therefore, arisen to obviate or at least mitigate the above-mentioned disadvantages.

### SUMMARY OF THE INVENTION

The main object of the present invention is to provide a torque wrench which may be connected to an output unit to receive and transmit a torque sensing signal and can be adjusted to provide various levels of output torques by turning a grip thereof.

To achieve the above and other objects, a torque wrench is provided, wherein the torque wrench includes: a main body defining an axial direction and including a work portion and a housing connected to each other, the work portion generating a warning sound when receiving a torque larger than a preset torque value, the housing being non-rotatably connected to the work portion, the housing including a first toothed portion; a grip rotatably connected to an end of the housing; a torque transmission mechanism including a torque adjustment member, the torque adjustment member being rotatably disposed in the main body, the preset torque value being adjustable by rotating the torque adjustment member; a torque sensing mechanism disposed on the main body and including a sensing assembly and an output port, the sensing assembly including a detecting unit and a sensing unit, the detecting unit being electrically connected to the output port, the torque adjustment member being configured to drive the sensing unit to move in the axial direction relative to the detecting unit, the detecting unit being configured to detect a position of the sensing unit to generate a torque sensing signal, the output port being disposed on the main body, the output port being configured to be electrically connected to an output unit to receive and transmit the torque sensing signal; an adjustment mechanism including a rotatable member, a driving member and a limitation member, the grip being disposed around and rotatable with the rotatable member, the rotatable member being disposed around and rotatable with the driving member, the rotatable member being movable between a first position and a second position in the axial direction relative to the grip, the driving member and the limitation member, the rotatable member including a second toothed portion, the driving member being disposed on the main body and non-movable in the axial direction, the driving member and the torque adjustment member being rotatable with each other, the torque adjustment member being movable in the axial direction relative to the driving member, the driving member and the limitation member being connected to each other in the axial direction; wherein when the rotatable member is in the first position, the second toothed portion of the rotatable member is engaged with the first toothed portion of the housing so that the rotatable member and the housing are rotatable with each other; when the rotatable member is in the second position, the second toothed portion of the rotatable member is disengaged from the first toothed portion of the housing; wherein when the rotatable member moves from the first position toward the second position, the rotatable member approaches toward the limitation member and blocks the limitation member in the axial direction.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of an exemplary embodiment of the present invention;

FIG. 2 is a breakdown drawing of an exemplary embodiment of the present invention;

FIG. 3 is a breakdown drawing of an adjustment mechanism of an exemplary embodiment of the present invention;

FIG. 4 is another breakdown drawing of the adjustment mechanism of an exemplary embodiment of the present invention;

FIG. 5 is a cross-sectional view of an exemplary embodiment of the present invention;

FIG. 6 is a cross-sectional view of a rotatable member in a first position according to an exemplary embodiment of the present invention;

FIG. 7 is a cross-sectional view of the rotatable member in a second position according to an exemplary embodiment of the present invention;

FIG. 8 is another stereogram of an exemplary embodiment of the present invention;

FIG. 9 is a partial cross-sectional view of an exemplary embodiment of the present invention;

FIG. 10 is a partial top view of an exemplary embodiment of the present invention;

FIG. 11 is another cross-sectional view of an exemplary embodiment of the present invention; and

FIG. 12 is a block diagram of an exemplary embodiment of the present invention.

### DETAILED DESCRIPTION OF THE PREFERRED EMBODIMENTS

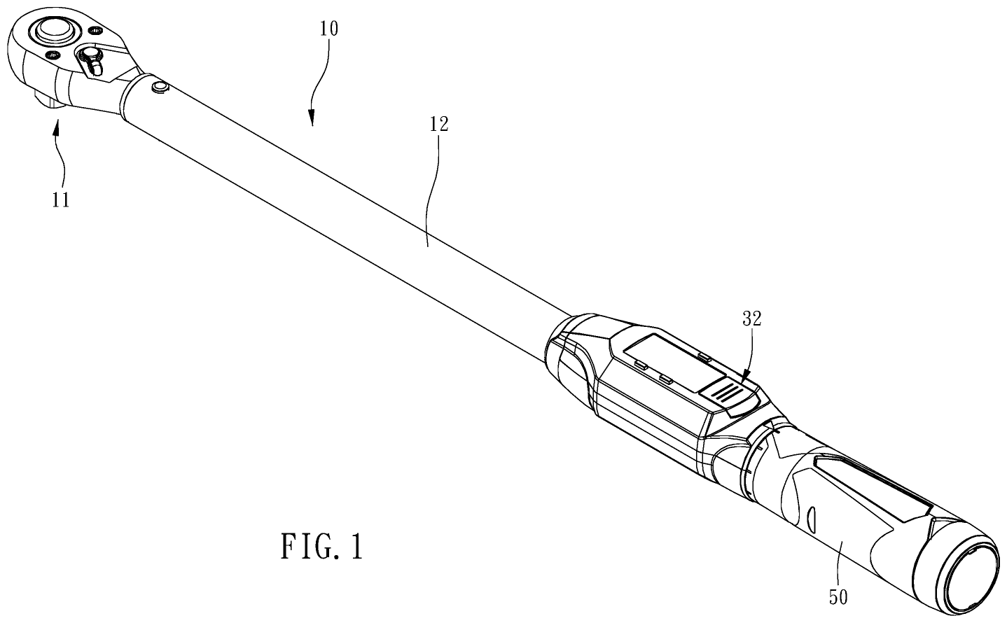

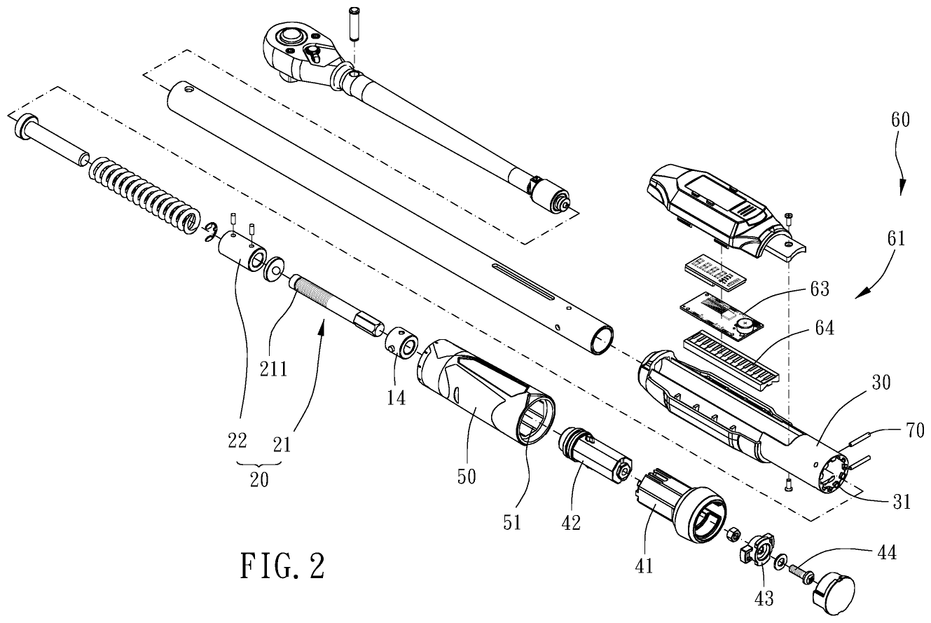

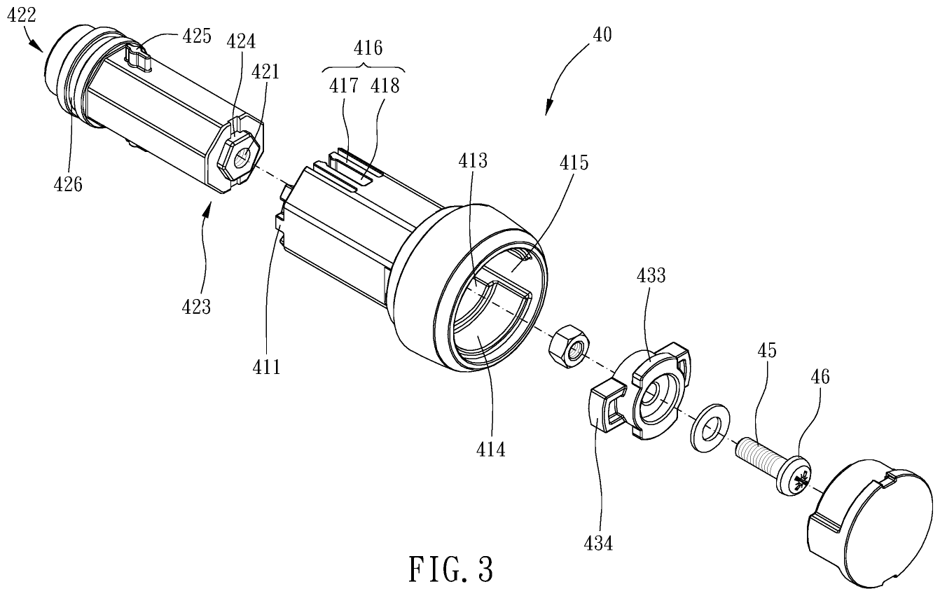

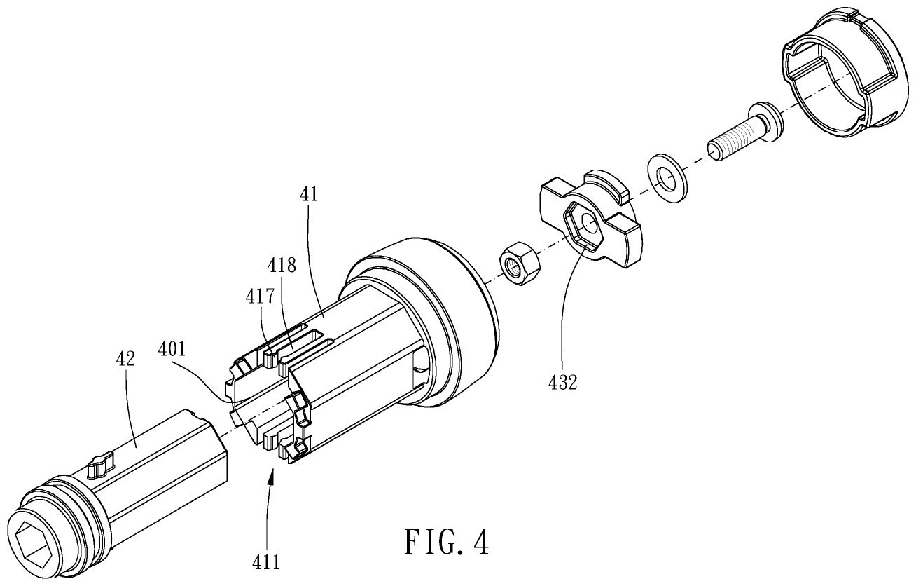

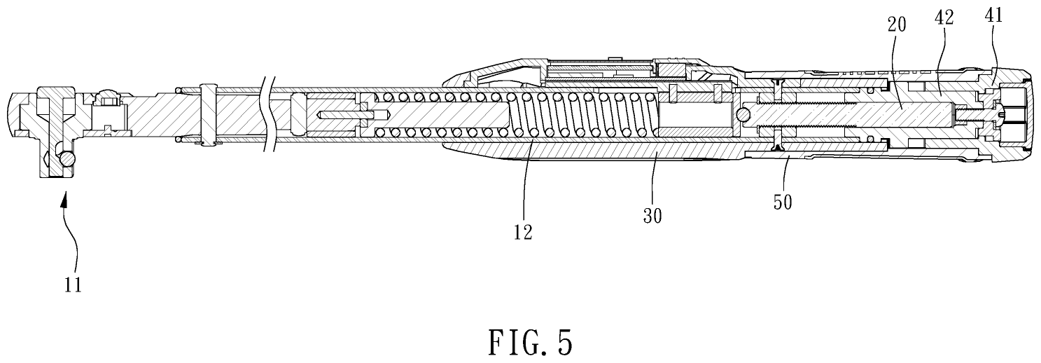

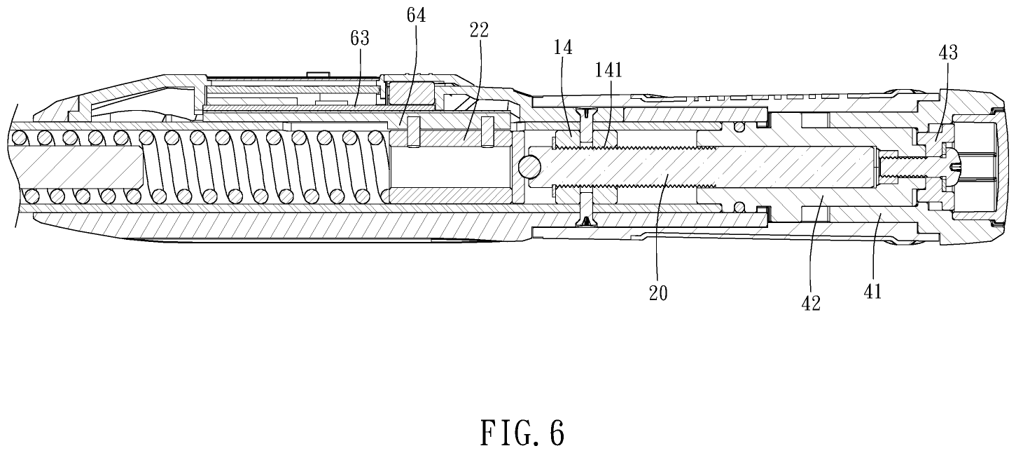

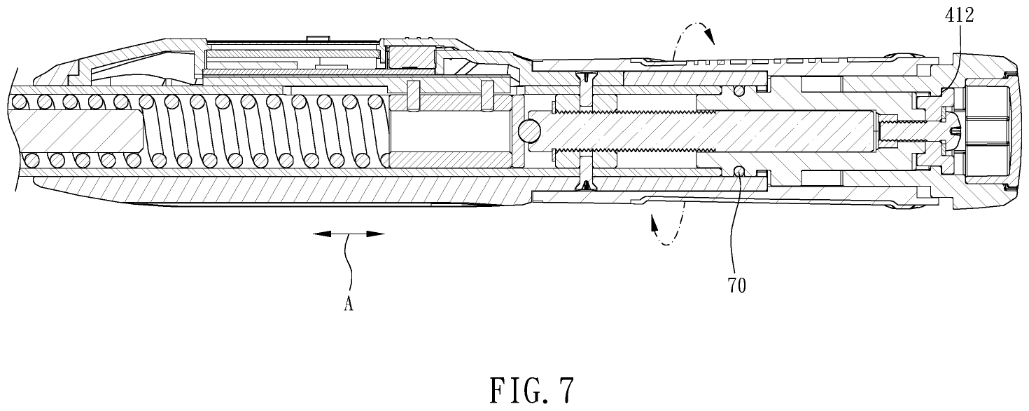

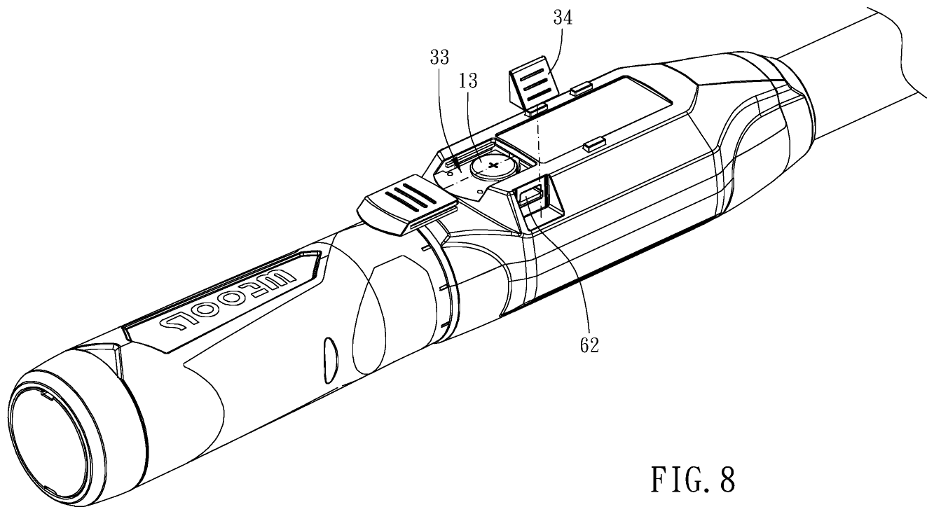

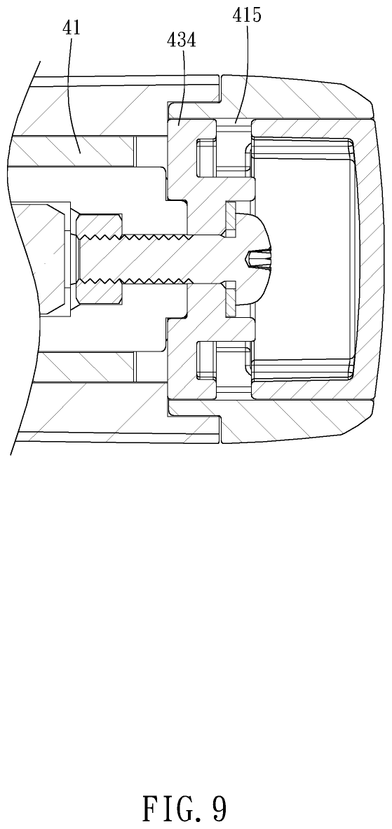

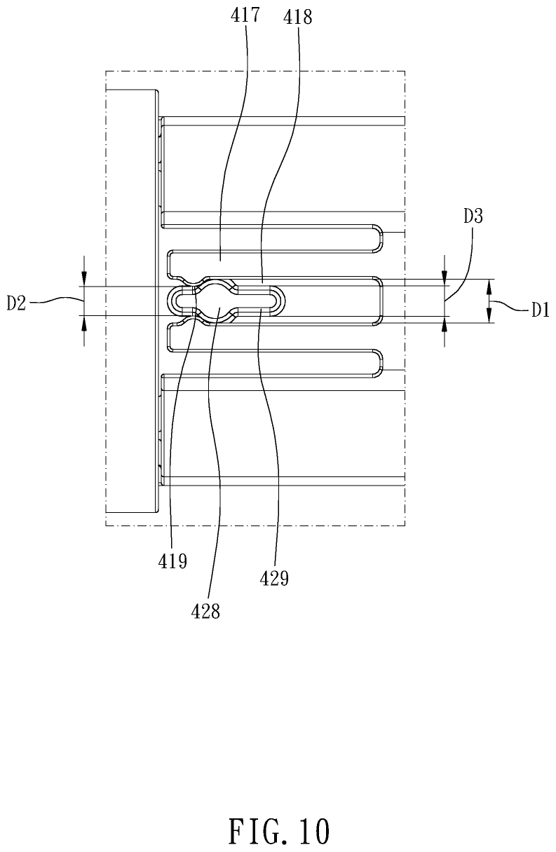

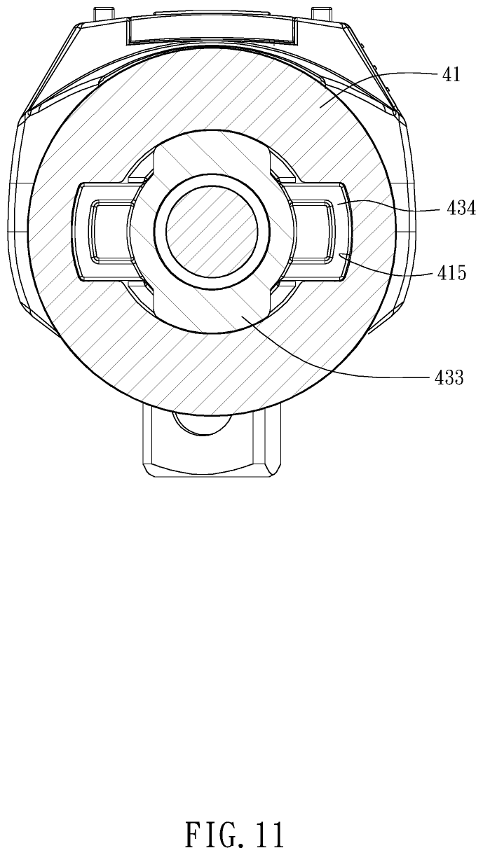

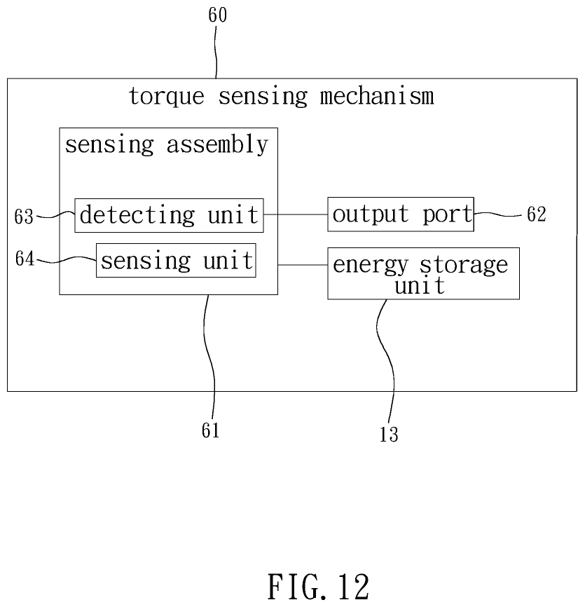

Please refer to FIGS. 1 to 12 for an exemplary embodiment of the present invention. A torque wrench of the present invention includes a main body 10, a grip 50, a torque transmission mechanism 20, a torque sensing mechanism 60 and an adjustment mechanism 40.

The main body 10 defines an axial direction A and includes a work portion 11 and a housing 30 connected to each other, the work portion 11 generates a warning sound when receiving a torque larger than a preset torque value, the housing 30 is non-rotatably connected to the work portion 11, and the housing 30 includes a first toothed portion 31. The grip 50 is rotatably connected to an end of the housing 30. The torque transmission mechanism 20 includes a torque adjustment member 21, the torque adjustment member 21 is rotatably disposed in the main body 10, and the preset torque value is adjustable by rotating the torque adjustment member 21. The torque sensing mechanism 60 is disposed on the main body 10, the torque sensing mechanism 60 includes a sensing assembly 61 and an output port 62, the sensing assembly 61 includes a detecting unit 63 and a sensing unit 64, the detecting unit 63 is electrically connected to the output port 62, the torque adjustment member 21 is configured to drive the sensing unit 64 to move in the axial direction A relative to the detecting unit 63, the detecting unit 63 is configured to detect a position of the sensing unit 64 to generate a torque sensing signal, the output port 62 is disposed on the main body 10, the output port 62 is configured to be electrically connected to an output unit (such as a transmission line) to receive and transmit the torque sensing signal. The adjustment mechanism 40 includes a rotatable member 41, a driving member 42 and a limitation member 43, the grip 50 is disposed around and rotatable with the rotatable member 41, the rotatable member 41 is disposed around and rotatable with the driving member 42, and the rotatable member 41 is movable between a first position and a second position in the axial direction A relative to the grip 50, the driving member 42 and the limitation member 43. The rotatable member 41 includes a second toothed portion 411, the driving member 42 is disposed on the main body 10 and non-movable in the axial direction A, the driving member 42 and the torque adjustment member 21 are rotatable with each other, the torque adjustment member 21 is movable in the axial direction A relative to the driving member 42, the driving member 42 and the limitation member 43 are connected to each other in the axial direction A. When the rotatable member 41 is in the first position, the second toothed portion 411 of the rotatable member 41 is engaged with the first toothed portion 31 of the housing 30 so that the rotatable member 41 and the housing 30 are rotatable with each other. When the rotatable member 41 is in the second position, the second toothed portion 411 of the rotatable member 41 is disengaged from the first toothed portion 31 of the housing 30 so that the rotatable member 41 is rotatable relative to the housing 30. When the rotatable member 41 moves from the first position toward the second position, the rotatable member 41 approaches toward the limitation member 43 and blocks the limitation member 43 in the axial direction A. Preferably, the rotatable member 41 is a polygonal barrel, the rotatable member 41 includes a polygonal engaging slot 401, and the driving member 42 is inserted in the polygonal engaging slot 401 and has a shape matching with a shape of the polygonal engaging slot 401. The grip 50 includes a polygonal hole 51, and the driving member 42 has a shape matching with a shape of the polygonal hole 51. As such, the data and/or information (the torque sensing signal, for example) can be transmitted to outside. The torque can be adjusted by turning the grip 50, which facilitates force adjustment, and the torque can be effectively transmitted to the torque adjustment member 21, which can reduce loss of force in the transmission process.

The main body 10 further includes a movable sleeve 14, and the movable sleeve 14 is disposed on the main body 10, non-rotatable relative to the main body 10 and axially non-movable. The torque adjustment member 21 includes an external threaded section 211, the movable sleeve 14 is disposed around the external threaded section 211, and the movable sleeve 14 includes an internal thread 141 screwed with the external threaded section 211 so that the torque adjustment member 21 is adjustable relative to the movable sleeve 14.

The main body further includes a tubular member 12, the housing 30 is disposed around the tubular member 12, and the sensing unit 64 is disposed on an outer side of the tubular member 12. The torque transmission mechanism 20 further includes a movable member 22, the movable member 22 is disposed in the tubular member 12 and movable in the axial direction A, the movable member 22 is connected to the sensing unit 64, and the torque adjustment member 21 is configured to drive the movable member 22 to move toward the work portion 11. The grip 50 is rotatably disposed around the tubular member 12.

The output port 62 is an electrical socket, and the electrical socket may be a USB socket, Mini-USB socket, Micro-USB socket, Lightning socket or Type-C USB socket.

The housing 30 further includes a receiving portion 32, the receiving portion 32 includes a receiving slot 33 and a cover 34, the cover 34 openably covers the receiving slot 33, the torque sensing mechanism 60 further includes an energy storage unit 13, the energy storage unit 13 is electrically connected to the detecting unit 63, and the energy storage unit 13 is received in the receiving slot 33. The energy storage unit 13 may be a button battery, which is easy to replace.

The adjustment mechanism 40 further includes a screw 44, the screw 44 includes a first threaded portion 45 and a head portion 46 connected to the first threaded portion 45, and the driving member 42 includes a second threaded portion 421 screwed with the first threaded portion 45. One of the first threaded portion 45 and the second threaded portion 421 is inserted in the limitation member 43, the head portion 46 is blocked by a side of the limitation member 43 opposite to the driving member 42, which is conducive to assembling or disassembling.

The driving member 42 includes a first lock portion 425, the rotatable member 41 further includes a second lock portion 416, the first lock portion 425 and the second lock portion 416 are locked with each other and releasable in the axial direction A, and the second lock portion 416 is blocked with the first lock portion 425 in the axial direction A. The first lock portion 425 and the second lock portion 416 are buckled with or unbuckled from each other in the axial direction A. Preferably, the first lock portion 425 is a bump, the first lock portion 425 has a largest outer diametric dimension D1, the second lock portion 416 includes a plurality of elastic arms 417, an engaging slot 418 and an insertion opening 419, the insertion opening 419 is open in the axial direction A, the plurality of elastic arms 417 are swingable relative to one another, the plurality of elastic arms 417 define the engaging slot 418 and the insertion opening 419, the insertion opening 419 is in communication with the engaging slot 418 and has a caliber dimension D2, and the insertion opening 419 allows the first lock portion 425 to pass therethrough in the axial direction A. The caliber dimension D2 is smaller than the largest outer diametric dimension D1. Preferably, the first lock portion 425 includes a large diameter section 428 and two small diameter sections 429, the two small diameter sections 429 are connected to opposing sides of the large diameter section 428, respectively, and each of the two small diameter sections 429 has an outer diametric dimension D3 smaller than or equal to the caliber dimension D2. By simply moving the rotatable member 41 in the axial direction A, it may be chosen to lock or unlock the rotatable member 41 in the first position so that it can move freely relative to the main body 10, providing quick switching.

The driving member 42 includes a first end portion 422 and a second end portion 423 in the axial direction A, the first end portion 422 is connected to the torque adjustment member 21, one of the second end portion 423 and the limitation member 43 includes a polygonal recess 432, the other of the second end portion 423 and the limitation member 43 includes a polygonal projection 424, and the polygonal projection 424 is received in the polygonal recess 432 in the axial direction A. Preferably, the rotatable member 41 further includes at least one first blocking portion 412 extending radially, the limitation member 43 further includes a second blocking portion 433 extending radially, and the at least one first blocking portion 412 and the second blocking portion 433 are blocked with each other in the axial direction A. The limitation member 43 further includes at least one guiding block 434 extending radially, the rotatable member 41 further includes a sleeving hole 413 and a surrounding wall 414, the driving member 42 is inserted in the sleeving hole 413, the surrounding wall 414 defines the sleeving hole 413, the surrounding wall 414 includes at least one groove 415, the at least one groove 415 extends in the axial direction A and in communication with the sleeving hole 413, and the at least one guiding block 434 is received in the at least one groove 415 and slidable in the axial direction A. In this embodiment, the surrounding wall 414 includes a plurality of grooves 415, and the limitation member 43 includes a plurality of guiding blocks 434. The plurality of guiding blocks 434 are received in the plurality of grooves 415, respectively. In axial direction A the plurality of guiding blocks 434 block the rotatable member 41 so that the rotatable member 41 can move smoothly in the axial direction A. The rotatable member 41 can drive the limitation member 43 to rotate, and the limitation member 43 can drive the driving member 42 to rotate, thus improving force transmission.

The torque wrench further includes at least one pin 70, the driving member 42 includes an annular recess 426, and the at least one pin 70 is disposed radially through the housing 30 and engaged within the annular recess 426. The driving member 42 is blocked by the at least one pin 70 in the axial direction A. As such, the driving member 42 is axially non-movable relative to the main body 10, and the at least one pin 70 is kept in the annular recess 426 during rotation.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A torque wrench including:
a main body defining an axial direction and including a work portion and a housing connected to each other, the work portion generating a warning sound when receiving a torque larger than a preset torque value, the housing being non-rotatably connected to the work portion, the housing including a first toothed portion;
a grip rotatably connected to an end of the housing;
a torque transmission mechanism including a torque adjustment member, the torque adjustment member being rotatably disposed in the main body, the preset torque value being adjustable by rotating the torque adjustment member;
a torque sensing mechanism disposed on the main body and including a sensing assembly and an output port, the sensing assembly including a detecting unit and a sensing unit, the detecting unit being electrically connected to the output port, the torque adjustment member being configured to drive the sensing unit to move in the axial direction relative to the detecting unit, the detecting unit being configured to detect a position of the sensing unit to generate a torque sensing signal, the output port being disposed on the main body, the output port being configured to be electrically connected to an output unit to receive and transmit the torque sensing signal;
an adjustment mechanism including a rotatable member, a driving member and a limitation member, the grip being disposed around and rotatable with the rotatable member, the rotatable member being disposed around and rotatable with the driving member, the rotatable member being movable between a first position and a second position in the axial direction relative to the grip, the driving member and the limitation member, the rotatable member including a second toothed portion, the driving member being disposed on the main body and non-movable in the axial direction, the driving member and the torque adjustment member being rotatable with each other, the torque adjustment member being movable in the axial direction relative to the driving member, the driving member and the limitation member being connected to each other in the axial direction;
wherein when the rotatable member is in the first position, the second toothed portion of the rotatable member is engaged with the first toothed portion of the housing so that the rotatable member and the housing are rotatable with each other; when the rotatable member is in the second position, the second toothed portion of the rotatable member is disengaged from the first toothed portion of the housing;
wherein when the rotatable member moves from the first position toward the second position, the rotatable member approaches toward the limitation member and blocks the limitation member in the axial direction.

2. The torque wrench of claim 1, wherein the output port is an electrical socket.

3. The torque wrench of claim 1, wherein the housing further includes a receiving portion, the receiving portion includes a receiving slot and a cover, the cover openably covers the receiving slot, the torque sensing mechanism further includes an energy storage unit, the energy storage unit is electrically connected to the detecting unit, and the energy storage unit is received in the receiving slot.

4. The torque wrench of claim 1, wherein the adjustment mechanism further includes a screw, the screw includes a first threaded portion and a head portion connected to the first threaded portion, the driving member includes a second threaded portion screwed with the first threaded portion, one of the first threaded portion and the second threaded portion includes the limitation member, and the head portion is blocked by a side of the limitation member opposite to the driving member.

5. The torque wrench of claim 1, wherein the driving member includes a first lock portion, the rotatable member further includes a second lock portion, the first lock portion and the second lock portion are locked with each other and releasable in the axial direction, and the second lock portion is blocked with the first lock portion in the axial direction; the first lock portion and the second lock portion are buckled with or unbuckled from each other in the axial direction.

6. The torque wrench of claim 5, wherein the first lock portion is a bump, the first lock portion has a largest outer diametric dimension, the second lock portion includes a plurality of elastic arms, an engaging slot and an insertion opening, the insertion opening is open in the axial direction, the plurality of elastic arms are swingable relative to one another, the plurality of elastic arms define the engaging slot and the insertion opening, the insertion opening is in communication with the engaging slot and has a caliber dimension, and the insertion opening allows the first lock portion to pass therethrough in the axial direction; the caliber dimension is smaller than the largest outer diametric dimension.

7. The torque wrench of claim 1, wherein the rotatable member is a polygonal barrel, the rotatable member includes a polygonal engaging slot, and the driving member is inserted in the polygonal engaging slot and has a shape matching with a shape of the polygonal engaging slot; the grip includes a polygonal hole, and the driving member has a shape matching with a shape of the polygonal hole.

8. The torque wrench of claim 1, wherein the driving member includes a first end portion and a second end portion in the axial direction, the first end portion is connected to the torque adjustment member, one of the second end portion and the limitation member includes a polygonal recess, and the other of the second end portion and the limitation member includes a polygonal projection.

9. The torque wrench of claim 1, further including at least one pin, wherein the driving member includes an annular recess, and the at least one pin is disposed radially through the housing and engaged within the annular recess; the driving member is blocked by the at least one pin in the axial direction.

10. The torque wrench of claim 6, wherein the main body further includes a tubular member, the housing is disposed around the tubular member, and the sensing unit is disposed on an outer side of the tubular member; the torque transmission mechanism further includes a movable member, the movable member is disposed in the tubular member and movable in the axial direction, the movable member is connected to the sensing unit, and the torque adjustment member is configured to drive the movable member to move toward the work portion; the grip is rotatably disposed around the tubular member; the rotatable member is a polygonal barrel, the rotatable member includes a polygonal recess, the driving member is inserted in the polygonal recess and has a shape matching with a shape of the polygonal recess; the grip includes a polygonal hole, and the driving member has a shape matching with a shape of the polygonal hole; the output port is an electrical socket; the housing further includes a receiving portion, the receiving portion includes a receiving slot and a cover, the cover openably covers the receiving slot, the torque sensing mechanism further includes an energy storage unit, the energy storage unit is electrically connected to the detecting unit, and the energy storage unit is received in the receiving slot; the adjustment mechanism further includes a screw, the screw includes a first threaded portion and a head portion connected to the first threaded portion, the driving member includes a second threaded portion screwed with the first threaded portion, one of the first threaded portion and the second threaded portion is inserted in the limitation member, and the head portion is blocked by a side of the limitation member opposite to the driving member; the driving member includes a first end portion and a second end portion in the axial direction, the first end portion is connected to the torque adjustment member, one of the second end portion and the limitation member includes a polygonal recess, and the other of the second end portion and the limitation member includes a polygonal projection inserted in the polygonal recess in the axial direction; the rotatable member further includes at least one first blocking portion extending radially, the limitation member further includes a second blocking portion extending radially, and the at least one first blocking portion and the second blocking portion are blocked with each other in the axial direction; the limitation member further includes at least one guiding block extending radially, the rotatable member further includes a sleeving hole and a surrounding wall, the driving member is inserted in the sleeving hole, the surrounding wall defines the sleeving hole, the surrounding wall includes at least one groove, the at least one groove extend in the axial direction and in communication with the sleeving hole, and the at least one guiding block is received in the at least one groove and slidable in the axial direction; in the axial direction the at least one guiding block blocks the rotatable member; the first lock portion includes a large diameter section and two small diameter sections, the two small diameter sections are connected to opposing sides of the large diameter section, respectively, and each of the two small diameter sections has an outer diametric dimension smaller than or equal to the caliber dimension; the torque wrench further includes at least one pin, the driving member includes an annular recess, and the at least one pin is disposed radially through the housing and engaged within the annular recess; the driving member is blocked by the at least one pin in the axial direction.
